(19) United States
(12) Patent Application Publication
(10) Pub. No.: US 2009/0311510 A1
(43) Pub. Date: Dec. 17, 2009

(54) Formable Sheet and Interior Finishing Material

(75) Inventors: Masanori Ogawa, Aichi (JP); Tsuyoshi Watanabe, Aichi (JP); Morimichi Hirano, Aichi (JP); Makoto Fujii, Aichi (JP)

Correspondence Address: COOPER & DUNHAM, LLP, 30 Rockefeller Plaza, 20th Floor, NEW YORK, NY, 10112, US

(73) Assignee: NAGOYA OILCHEMICAL CO., LTD., Tokai-shi (JP)

(21) Appl. No.: 11/919,465

(22) PCT Filed: Apr. 21, 2006
(86) PCT No.: PCT/JP2006/308452

§ 371 Date: Oct. 26, 2007

(30) Foreign Application Priority Data
Apr. 26, 2005 (JP) 2005-127637

(51) Int. Cl. B32B 3/26

(52) U.S. Cl. 428/320.2

(57) ABSTRACT

The object of the present invention is to provide a moldable sheet which maintains good moldability even in a case where the moldable sheet is kept at a low temperature and a low humidity.

The moldable sheet comprises a porous material which a synthetic resin is coated on or impregnated into, the porous material being further impregnated with a water retention agent.

The water retention agent in the porous material retains moisture in the porous material, maintaining the good moldability of the moldable sheet, even at a low temperature and a low humidity.

### FIELD OF THE INVENTION

The present invention relates to a moldable sheet which is used as, for example, a surface material for automobile interiors, and also relates to the interior material made using said moldable sheet.

### BACKGROUND OF THE INVENTION

Hitherto, a moldable sheet comprising a porous material such as a fiber sheet in to which a synthetic resin is impregnated to give said fiber sheet moldability has been provided as, for example, a surface material of the interiors of a car (see Patent Literatures 1 to 4).

Patent Literature 1: Tokkaihei 11-263170

Patent Literature 2: Tokkai 2000-62543

Patent Literature 3: Tokkai 2000-327797

Patent Literature 4: Tokkai 2003-326628

### DISCLOSURE OF THE INVENTION

### The Problems to be Solved

Said moldable sheet may be in absolute dry conditions in a low humidity atmosphere, and further especially at a low temperature, said moldable sheet may harden, and the elongation of said moldable sheet may deteriorate, degrading the moldability of said moldable sheet, creating a problem in that when said moldable sheet is put on to a base material and hot press molded wrinkles are formed on the surface of the resulting molded sheet.

### Means to Solve Said Problems

As the means to solve the problems, the present invention provides a moldable sheet comprising a porous material which a synthetic resin is coated on, or impregnated into, said porous material being further impregnated with a water retention agent.

Said synthetic resin is preferably a phenol group resin and at B-stage in said porous material, and further said phenol group resin is preferably sulfo and/or sulfi methylated. Moreover, said water retention agent is preferably a polyhydric alcohol.

Said synthetic resin is impregnated into said porous material in an amount of between 5 and 200% by mass, and said water retention agent is impregnated into said porous material in an amount of between 0.1˜50% by mass for said synthetic resin.

Still further, the present invention provides an interior material which is made by putting said moldable sheet as a surface material on to a base material and hot press-molding.

### EFFECT OF THE INVENTION

[Action]

In said moldable sheet of the present invention, even in a low humidity atmosphere, said water retention agent in said moldable sheet retains moisture to prevent said moldable sheet from being in an absolute dry state, so that equilibrium moisture percentage in said moldable sheet can be maintained in the range of between 3 and 20% by mass, to secure adequate elongation of said moldable sheet for smooth molding.

In a case where said synthetic resin is a phenol group resin and at B-stage in said porous material, said moldable sheet can be stored for a long time, and when molded said phenol group resin in said porous material is quickly cured by heating.

In a case where said phenol group resin is sulfo and/or sulfi methylated, the aqueous solution of said phenol group resin stabilizes in the wide pH range, making said moldable sheet more stable.

In a case where said water retention agent in said porous material is a polyhydric alcohol, since said polyhydric alcohol has a low toxicity, said moldable sheet can be safely treated and further said polyhydric alcohol, being chemically stable, will not act to corrode said porous material.

[Effect]

Accordingly, said moldable sheet shows adequate elongation when said moldable sheet is put on the base material and hot press-molded, resulting in the present invention providing a high quality interior material free of surface defects such as wrinkles.

The present invention is described precisely below.

### The Preferred Embodiment

[Porous Material]

Said porous material used in the present invention is such as a fiber material, synthetic resin foam and the like.

In the present invention, said porous material is used as mainly a porous material sheet such as a fiber sheet, synthetic resin foam sheet or the like.

[Fiber]

Fibers used in the present invention include polyolefine group fibers such as polyester fiber, polyamide fiber, acrylic fiber, urethane fiber, polyvinylchloraide fiber, polyvinylidenechloraide fiber, acetate fiber, polyethylene fiber, polypropylene fiber, or the like, synthetic fibers such as aramid fiber, or the like, natural fibers such as wool, mohair, cashmere, camel hair, alpaca, vicuna, angora, silk, raw cotton, cattail fiber, pulp, cotton, coconut fiber, hemp fiber, bamboo fiber, kenaf fiber, or the like, biodegradable fibers such as starch group fiber, polylactic acid group fiber, chitin chitosan group fiber, or the like, cellulose group synthetic fibers such as rayon fiber, polynosic fiber, cuprammonium rayon fiber, acetate fiber, triacetate fiber, or the like, inorganic fibers such as glass fiber, carbon fiber, ceramic fiber, asbestos fiber, or the like, and reclaimed fibers obtained by the fiberizing of fiber products made of said fibers.

Said fiber can be used singly or two or more kinds of said fiber can be used together in the present invention.

The fineness of said synthetic fiber or inorganic fiber may commonly be in the range of between 0.01 and 30 dtex, while said natural plant fiber may commonly be in the range of between 0.01 and 1.0 mm.

Further, desirable fiber is hollow fiber. Said hollow fiber is made of a thermoplastic resin such as polyester such as polyethylent telephthalate, polybutylene telephthalate, polyhexamethylene telephthalate, poly 1,4-dimethylcyclohexane telephthalate, or the like, poliamide such as nylon 6, nylon 66, nylon 46, nylon 10, or the like, polyolefine such as polyethylene, polypropylene, or the like, and acryl, urethane, polyvinylchloraide polyvinylidenechloraide, acetate, or the like.

Said hollow fiber can be used singly or two or more kinds of said hollow fiber can be used together.

Said hollow fiber is manufactured by well known methods such as melt spinning, or the selective dissolving out of one component from a composite fiber having been manufactured by bicomponent spinning of two kinds of polymer.

One or more tuberous hollow part(s), with cross section(s) that is/are circular, elliptical, or the like is (are) formed in said hollow fiber, the ratio of the hollow part being in the range of between 5% and 70%, but desirably 10% and 50%. The ratio of the hollow part is defined as the ratio of the cross sectional area of the hollow part to the cross sectional area of fiber.

The fineness of said hollow fiber is in the range of between 1 and 50 dtex, but desirably 2 and 20 detx.

In a case where said hollow fiber is used with other fibers, said hollow fiber is desirably mixed in with said mixed fiber in an amount of more than 10% by mass.

In a case where said hollow fiber is used, the rigidity of the resulting fiber sheet can be improved by its tuberous effect.

Further, fiber having a low melting point lower than 180° C. may be used in the present invention. Said fiber having a low melting point may include such as polyolefine group fibers like polyethylene, polypropylene, ethylene-vinyl acetate copolymer, ethylene-ethyl acrylate copolymer, and polyvinylchloraide fiber, polyurethane fiber, polyester fiber, polyester copolymer fiber, polyamide fiber, polyamide copolymer fiber or a composite fiber having a skin-core-structure consisting of cores made of an ordinary fiber having a melting point higher than 180° C., and skin made of said fiber having a low melting point. Said fiber having a low melting point can be used singly, or two or more kinds of said fiber can be used together.

The fineness of said fiber having a low melting point is in the range of between 0.1 and 60 detx and said fiber can be mixed in with said ordinary fiber in an amount of between 1 and 50% by mass.

[Fiber Sheet]

The fiber sheet in the present invention is commonly provided as non-woven fabrics, woven fabrics or knitting. Said non-woven fabrics include needle punched fabrics, resin non-woven fabrics which use a synthetic resin binder as mentioned below, spunbounded non-woven fabrics made of said fiber having a low melting point, or a fiber mixture containing said fiber having a low melting point, and ordinary fibers, or fused non-woven fabrics produced by the heat treatment of needle punched non-woven fabrics, and by the fusion of said fibers to one another.

[Synthetic Resin Foam]

The synthetic resin foam used in the present invention includes such as polyurethane foam of both soft type and hard type, said polyurethane foam having an open cell structure, a polyolefin foam such as polyethylene, polypropylene, or the like, polyvinyl chloride foam, polystyrene foam, acrylnitrile-butadiene-styrene copolymer foam, an amino group resin foam such as melamine resin, urea resin, or the like, epoxy resin foam, a phenol group resin foam made of a phenol group compound such as monohydric phenol, polyhydric phenol, or the like.

In the present invention, said synthetic resin foam is used for a synthetic resin foam sheet.

[Synthetic Resin]

A synthetic resin is coated on or impregnated into said porous material such as said fiber sheet, said synthetic resin sheet, and the like.

In the case of said resin non-woven fabric, since a synthetic resin is used as its binder, it is not always necessary for said non-woven fabric to be coated or impregnated, but if said synthetic binder is used in a small amount in said resin non-woven fabric, synthetic resin is further coated on or impregnated into said resin non-woven fabric to give it moldability.

The synthetic resin which can be used for said binder of fibers includes such as thermoplastic resin such as polyethylene, polypropylene, ethylene-propylene copolymer, ethylene-vinyl acetate copolymer, polyvinylchloraide, polyvinylidenechloraide, polysttyrene, polyvinylacetate, fluoric resin, thermoplastic acrylic acid resin, thermoplastic polyester, thermoplastic polyamide, thermoplastic urethane resin, acrylonitrile-butadiene copolymer, styrene-butadiene copolymer, acrylonitrile-butadiene-styrene copolymer, ethylene-propylene copolymer, ethylene-propylene terpolymer, ethylene-vinylacetate copolymer, or the like, thermosetting resin such as urethane resin, melamine resin, heat hardening type acrylic resin, urea resin, phenol resin, epoxy resin, thermosetting type polyester resin, or the like, and further, synthetic resin precursor to produce said synthetic resin may be used. Said synthetic resin precursor may include such as prepolymer, oligomer, monomer or the like, urethane resin prepolymer, epoxy resin prepolymer, melamine resin prepolymer, urea resin prepolymer, phenol resin prepolymer, diallyl phthalate prepolymer, acrylic oligomer, polyisocyanate, methacryl ester monomer, diallyphthalated monomer, or the like.

Said synthetic resin can be used singly or two or more kinds of said synthetic resin can be used together. Said synthetic resin is usually provided as an emulsion, a latex, an aqueous solution, an organic solvent solution or the like. A desirable synthetic resin which is to be used as a binder in this invention is phenol group resin. Said phenol group resin is illustrated precisely below.

[Phenol Group Resin]

Phenol group resin is produced by the condensation reaction between a phenol group compound, and an aldehyde, and/or aldehyde donor. To give said phenol group resin water solubility, said phenol group resin may be sulfo and/or sulfimethylated.

Said phenol group resin is impregnated into a sheet base material as a water solution of a precondensate (precondensate solvent). For said precondensate solvents, if desired, a water soluble organic solvent may be used. Said water soluble organic solvent is such as an alcohol group solvent like methanol, ethanol, n-propanol, isopropanol, n-butanol, isobutanol, s-butanol, t-butanol, n-amyl alcohol, isoamyl alcohol, n-hexanol, methylamyl alcohol, 2-ethylbutanol, n-heptanol, n-octanol, trimethylnonyl alcohol, cyclohexanol, benzyl alcohol, furfuryl alcohol, tetrahydrofurfuryl alcohol, abiethyl alcohol, diacetone alcohol, or the like, ketone group solvent such as acetone, methylacetone, ethyl methyl ketone, methyl n-propyl ketone, methyl n-butyl ketone, isobutyl methyl ketone, diethyl ketone, di-n-propyl ketone, diisobutyl ketone, acetonylacetone, methyl oxide, cyclohexanone, methylcyclohexanone, acetophenone, camphor, or the like, glycol group solvent such as ethylene glycol, diethylene glycol, triethylene glycol, propylene glycol, trimethylene glycol, polyethylene glycol, or the like, glycol ether group solvent such as ethylene glycol monomethyl ether, ethylene glycol monoethyl ether, ethylene glycol isopropyl ether, diethylene glycol monomethyl ether, monomethyl triethylene glycol ether, or the like, ester of said glycol group solvent or derivative thereof such as ethylene glycol diacetate, diethylene glycol monoethyl ether acetate, or the like, ether group solvent such as 1,4-dioxane, or the like, and further diethyl cellosolve diethylcarbitol, ethyl lactate, isopropyl lactate, diglycol diacetate, dimethyl formamide, or the like.

(Phenol Group Compound)

The phenolic compound used to produce said phenolic resin may be monohydric phenol, or polyhydric phenol, or a mixture of monohydric phenol and polyhydric phenol, but in a case where only monohydric phenol is used, formaldehyde is apt to be emitted when or after said resin composition is cured, so that polyhydric phenol or a mixture of monohydric phenol and polyhydric phenol is preferably used.

(Monohydric Phenol)

The monohydric phenols include alkyl phenols such as o-cresol, m-cresol, p-cresol, ethylphenol, isopropylphenol, xylenol, 3,5-xylenol, butylphenol, t-butylphenol, nonylphenol, or the like; monohydric phenol derivatives such as o-fluorophenol, m-fluorophenol, p-fluorophenol, o-chlorophenol, m-chlorophenol, p-chlorophenol, o-bromophenol, m-bromophenol, p-bromophenol, o-iodophenol, m-iodophenol, p-iodophenol, o-aminophenol, m-aminophenol, p-aminophenol, o-nitrophenol, m-nitrophenol, p-nitrophenol, 2,4-dinitrophenol, 2,4,6-trinitrophenol, or the like; monohydric phenols of polycyclic aromatic compounds such as naphthol, or the like. Each monohydric phenol can be used singly, or in a mixture thereof.

(Polyhydric Phenol)

The polyhydric phenols mentioned above, include resorcin, alkylresorcin, pyrogallol, catechol, alkylcatechol, hydroquinone, alkylhydroquinone, phloroglucinol, bisphenol, dihydroxynaphthalene, or the like. Each polyhydric phenol can be used singly, or in a mixture thereof Resorcin and alkylresorcin are more suitable than other polyhydric phenols. Alkylresorcin, in particular, is the most suitable of polyhydric phenols, because it can react with aldehydes more rapidly than resorcin.

The alkylresorcins include 5-methylresorcin, 5-ethylresorcin, 5-propylresorcin, 5-n-butylresorcin, 4,5-dimethylresorcin, 2,5-dimethylresorcin, 4,5-diethylresorcin, 2,5-diethylresorcin, 4,5-dipropylresorcin, 2,5-dipropylresorcin, 4-methyl-5-ethylresorcin, 2-methyl-5-ethylresorcin, 2-methyl-5-propylresorcin, 2,4,5-trimethylresorcin, 2,4,5-triethylresorcin, or the like.

A polyhydric phenol mixture produced by the dry distillation of oil shale, which is produced in Estonia, is inexpensive, said polyhydric phenol mixture including 5-metylresorcin, along with many other kinds of alkylresorcin, and is highly reactive, making said polyhydric phenol mixture an especially desirable raw polyphenol material.

In the present invention, said phenolic compound and aldehyde and/or aldehyde donor (aldehydes) are condensed together. Said aldehyde donor refers to a compound or a mixture which emits aldehyde when said compound or said mixture decomposes. The aldehydes include formaldehyde, acetaldehyde, propionaldehyde, chloral, furfural, glyoxal, n-butylaldehyde, capronaldehyde, allylaldehyde, benzaldehyde, crotonaldehyde, acrolein, phenylacetaldehyde, o-tolualdehyde, salicylaldehyde, or the like. The aldehyde donors include paraformaldehyde, trioxane, hexamethylenetetramine, tetraoxymethylene, or the like.

As described above, said phenolic resin is desirably sulfo and/or sulfialkylated, to improve the stability of said water soluble phenolic resin.

(Sulfomethylation Agent)

The sulfomethylation agents used to improve the stability of the aqueous solution of phenol resins, include such as water soluble sulfites prepared by the reaction between sulfurous acid, bisulfurous acid, or metabisulfirous acid, and alkaline metals, trimethylamine, quaternary ammonium (e.g. benzyltrimethylammonium); and aldehyde adducts prepared by the reaction between said water soluble sulfites and aldehydes.

The aldehyde adducts are prepared by the addition reaction between aldehydes and wafer soluble sulfites as mentioned above, wherein the aldehydes include formaldehyde, acetaldehyde, propionaldehyde, chloral, furfural, glyoxal, n-butylaldehyde, capronaldehyde, allylaldehyde, benzaldehyde, crotonaldehyde, acrolein, phenylacetaldehyde, o-tolualdehyde, salicylaldehyde, or the like. For example, hydroxymethane sulfonate, which is one of the aldehyde adducts, is prepared by the addition reaction between formaldehyde and sulfite.

(Sulfimethylation Agent)

The sulfimethylation agents used to improve the stability of the aqueous solution of phenol resins, include alkaline metal sulfoxylates of aliphatic or aromatic aldehyde such as sodium formaldehyde sulfoxylate (a.k.a. Rongalit), sodium benzaldehyde sulfoxylate, or the like; hydrosulfites (a.k.a. dithionites) of alkaline metal or alkaline earth metal such as sodium hydrosulfite, magnesium hydrosulfite, or the like; hydroxyalkanesulfinate such as hydroxymethanesulfinate, or the like.

When producing said phenol resins, if necessary, additives may be mixed in with said phenol resins as a catalyst, or to adjust the pH. Such additives include acidic compounds and alkaline compounds. Said acidic compounds include inorganic acid or organic acid such as hydrochloric acid, sulfuric acid, orthophosphoric acid, boric acid, oxalic acid, formic acid, acetic acid, butyric acid, benzenesulfonic acid, phenolsulfonic acid, p-toluenesulfonic acid, naphthalene-α-sulfonic acid, naphthalene-β-sulfonic acid, or the like; esters of organic acid such as dimethyl oxalate, or the like; acid anhydrides such as maleic anhydride, phthalic anhydride, or the like; salts of ammonium such as ammonium chloride, ammonium sulfate, ammonium nitrate, ammonium oxalate, ammonium acetate, ammonium phosphate, ammonium thiocyanate, ammonium imidosulfonate, or the like; halogenated organic compounds such as monochloroacetic acid, the salt thereof, organic halogenides such as α,α′-dichlorohydrin, or the like; hydrochloride of amines such as triethanolamine hydrochloride, aniline hydrochloride, or the like; urea adducts such as the urea adduct of salicylic acid, urea adduct of stearic acid, urea adduct of heptanoic acid, or the like; and N-trimethyltaurine, zinc chloride, ferric chloride, or the like; alkaline compounds including ammonia, amines; hydroxides of alkaline metal and alkaline earth metal such as sodium hydroxide, potassium hydroxide, barium hydroxide, calcium hydroxide, and the like; oxide of alkaline earth metal such as lime, or the like; salts of alkaline metal such as sodium carbonate, sodium sulfite, sodium acetate, sodium phosphate, or the like.

(Method of Producing the Phenol Resins)

Phenol resins (precondensation polymers) can be prepared using the usual method. The usual methods including method (a) comprising the condensation of a monohydric phenol and/or a polyhydric phenol and aldehydes; method (b) comprising the condensation of a precondensation polymer and a monohydric phenol and/or a polyhyrdric phenol, wherein said precondensation polymer comprises a monohydric phenol and aldehydes; method (c) comprising the condensation of a precondensation polymer and a monohydric phenol and/or a polyhydric phenol, wherein said precondensation polymer comprises a monohydric phenol, a polyhydric phenol and aldehydes; method (d) comprising the condensation of a precondensation polymer consisting of a monohydric phenol and aldehydes, with a precondensation polymer consisting of a polyhydric phenol and aldehydes; and method (e) comprising the condensation of a precondensation polymer consisting of a monohydric phenol and aldehydes and/or precondensation polymers consisting of a polyhydric phenol and aldehydes, with a precondensation polymer consisting of a monohydric phenol and polyhydric phenol and aldehydes.

In the present invention, the desirable phenolic resin is phenol-alkylresorcin cocondensation polymer. Said phenol-alkylresorcin cocondensation polymer provides a water solution of said cocondensation polymer (pre-cocondensation polymer) having good stability, and being advantageous in that it can be stored for a longer time at room temperature, compared with a condensate consisting of a phenol only (precondensation polymer). Further, in a case where said water solution is impregnated into a sheet base material, after which said sheet base material is precured to produce a porous material sheet, such as a fiber sheet, a synthetic resin foam sheet, and the like, said porous material sheet has good stability, so that said porous material sheet maintains good moldability for a long time. Further, since alkylresorcin is highly reactive to aldehyde, and catches free aldehyde to react with it, the content of free aldehyde in the resin can be reduced.

Said phenol-alkylresorcin cocondensation polymer is also advantageous in that the content of free aldehyde in said polymer is reduced by the reaction with alkylresorcin.

The desirable method for producing said phenol-alkylresorcin cocondensation polymer is first to create a reaction between phenol and aldehyde to produce a phenolic precondensation polymer, and then to add alkylresorcin, and if desired, aldehyde, to said phenolic precondensation polymer to create a reaction.

In the case of method (a), for the condensation of monohydric phenol and/or polyhydric phenol and aldehydes, the aldehydes (0.2 to 3 moles) are added to said monohydric phenol (1 mole), then said aldehydes (0.1 mole to 0.8 mole) are added to the polyhydric phenol (1 mole) as usual. If necessary, additives may be added to the phenol resins (the precondensation polymers). In said method(s), there is a condensation reaction from heating at 55° C. to 100° C. for 8 to 20 hours. The addition of aldehydes may be made at one time at the beginning of the reaction, or several separate times throughout the reaction, or said aldehydes may be dropped in continuously throughout said reaction.

In the case of sulfo and/or sulfimethylation, the sulfomethylation agents and/or sulfimethylation agents may be added to the precondensation polymers at an arbitrary time.

The addition of said sulfomethylation agents and/or sulfimethylation agents may be made at any time, such as before, during, or after condensation.

The total amount of said sulfomethylation agent and/or sulfimethylation agent added is usually in the range of between 0.001 and 1.5 moles per 1 mole of phenol. In a case where said amount added is less than 0.001 mole, the hydrophile of the resulting sulfo and/or sulfimethylated phenolic resin is not adequate, and in a case where said amount added is more than 1.5 moles, the water resistance of the resulting sulfo and/or sulfimethylated phenolic resin degrades. To provide excellent curing properties in the resulting precondensate and excellent physical properties in the cured resin, said amount to be added is preferably in the range of between 0.01 and 0.8 mole per 1 mole of phenol.

The sulfomethylation agents and/or sulfimethylation agents for sulfo and/or sulfimethylation react with the methylol groups and/or aromatic groups, so that the sulfomethyl group and/or sulfimethyl group are introduced to the precondensation polymers.

The solution of precondensation polymers of sulfo and/or sulfimethylated phenol resins is stable even in a wide range of acidic condition (e.g. pH=1.0) or alkaline condition, so that the solution can be cured under any conditions such as acid, neutral or alkaline. In the case of curing the precondensate under acidic condition, there is a decrease in the remaining methylol groups, so that no formaldehydes from the decomposed cured phenol resins appear. In a case where a sulfo and/or sulfimethylated phenol resin is used as a synthetic resin binder, a fire retardant porous sheet such as a fiber sheet or a synthetic resin foam sheet with greater fire retardancy is produced, in comparison with a case where nonsulfo and/or nonsulfimethylated phenolic resin is used.

Further, if desired, the phenol resins and/or precondensation polymers thereof may be copolycondensed with amino resin monomers such as urea, thiourea, melamine, thiomelamine, dicyandiamine, guanidine, guanamine, acetoguanamine, benzoguanamine, 2,6-diamino-1,3-diamine, or the like.

Further, curing agents such as an aldehyde and/or an aldehyde donor or an alkylol triazine derivative, or the like, may be added to said phenolic precondensation polymer (including precocondensation polymer).

As said aldehyde and/or aldehyde donor, the same aldehyde and/or aldehyde donor as used in the production of said phenolic precondensation polymer is (are) used, and alkylol triazine derivatives are produced by the reaction between urea group compound, amine group compound, and aldehyde and/or aldehyde donor. Said urea group compound used in the production of said alkylol triazined derivatives may be such as urea, thiourea, and alkylurea such as methylurea, an alkylthiourea such as methylthiourea; phenylurea, naphthylurea, halogenated phenylurea, nitrated alkylurea, or the like, or a mixture of two or more kinds of said urea group compounds. A particularly, desirable urea group compound may be urea or thiourea. As the amine group compounds, aliphatic amine such as methyl amine, ethylamine, propylamine, isopropylamine, butylamine, amylamine or the like, benzylamine, furfuryamine, ethanolamine, ethylenediamine, hexamethylenediamine hexamethylenetetramine, or the like, as well as ammonia are illustrated, and said amine group compound can be used singly or two or more amine group compounds can be used together.

The aldehyde and/or aldehyde donor used for the production of said alkylol triazine derivative is (are) the same as the aldehyde and/or aldehyde donor used for the production of said phenolic precondensation polymer.

To synthesize said alkylol triazine derivatives, commonly 0.1 to 1.2 moles of said amine group compound(s) and/or ammonia, and 1.5 to 4.0 moles of aldehyde and/or aldehyde donor are combined to react with 1 mole of said urea group compound.

In said reaction, the order in which said compounds are added is arbitrary, but preferably, the required amount of aldehyde and/or aldehyde donor is (are) first to be put in a reactor, after which the required amount of amine group compound(s) and/or ammonia is (are) gradually added to said aldehyde and/or aldehyde donor, the temperature being kept at below 60° C., after which the required amount of said urea group compound(s) is (are) added to the resulting mixture; after which said mixture is agitated and heated at 80 to 90° C. for 2 to 3 hours, so as to react. Usually, 37% by mass of formalin is used as said aldehyde and/or aldehyde donor, but some of said formalin may be replaced with paraformaldehyde to increase the concentration of the reaction product.

Further, in a case where hexamethylenetetramine is used, the solid content of the reaction product obtained is much higher. The reaction between said urea group compound, said amine group compound and/or ammonia and said aldehyde and/or aldehyde donor is commonly performed in a water solution, but said water may be partially or wholly replaced by one or more kinds of alcohol(s) such as methanol, ethanol, isopropanol, n-butanol, ethylene glycol, diethylene glycol, or the like, and one or more kinds of other water soluble solvent(s) such as a ketone group solvent like acetone, ethyl methyl ketone, or the like can also be used as solvents.

The amount of said curing agent to be added is, in the case of an aldehyde and/or aldehyde donor, in the range of between 10 and 100 parts by mass to 100 parts by mass of said phenolic precondensation polymer (precopolycondensation polymer), and in the case of alkylol triazine, 10 to 500 parts by mass to 100 parts by mass of said phenolic precondensation polymer (precopolycondensation polymer).

Inorganic fillers such as calcium carbonate, magnesium carbonate, barium sulfate, calcium sulfate, calcium sulfite, calcium phosphate, calcium hydroxide, magnesium hydroxide, aluminum hydroxide, magnesium oxide, titanium oxide, iron oxide, zinc oxide, alumina, silica, diatom earth, dolomite, gypsum, talc, clay, asbestos, mica, calcium silicate, bentonite, white carbon, carbon black, iron powder, aluminum powder, glass powder, stone, powder, blast furnace slag, fly ash, cement, zirconia powder or the like; natural rubber or its derivative; synthetic rubber such as styrene-butadiene rubber, acrylonitrile-butadiene rubber, chloroprene rubber, ethylene-propylene rubber, isoprene rubber, isoprene-isobutylene rubber or the like; water-soluble macromolecule and natural gum such as polyvinyl alcohol, sodium alginate, starch, starch derivative, glue, gelatin, powdered blood, methyl cellulose, carboxymethyl cellulose, hydroxyl ethyl cellulose, polyacrylate, polyacrylamide, or the like; fillers such as calcium carbonate, talc, gypsum, carbon black, wood flour, walnut powder, coconut shell flour, wheat flour, rice flour, or the like; surface active agent; higher fatty acid such as stearic acid, palmitic acid, or the like; fatty alcohols such as palmityl alcohol, stearyl alcohol, or the like; fatty acid esters such as butyryl stearate, glycerin mono stearate or the like; fatty acid amide; natural wax or composition wax such as carnauba wax or the like; mold release agents such as paraffin, paraffin oil, silicone oil, silicone resin, fluoric resin, polyvinyl alcohol, grease, or the like; organic blowing agents such as azodicarbonamido, dinitroso pentamethylene tetramine, P,P′-oxibis(benzene sulfonylhydrazide), azobis-2,2′-(2-methylglopionitrile), or the like; inorganic blowing agents such as sodium bicarbonate, potassium bicarbonate, ammonium bicarbonate or the like; hollow particles such as shirasu balloon, perlite, glass balloon, foaming glass, hollow ceramics, or the like; foaming bodies or particles such as foaming polyethylene, foaming polystyrene, foaming polypropylene, or the like; pigment; dye; an antioxidant; an antistatic agent; a crystallizer; flame retardants such as a phosphorus compound, nitrogen compound, sulfur compound, boron compound, bromine compound, guanidine compound, phosphate compound, phosphate ester compound, amino resin, or the like; a flameproof agent; water-repellent agent; oil-repellent agent; insecticide agent; preservative; wax; surfactants; lubricants; antioxidants, ultraviolet stabilizers; plasticizers such as phthalic ester (ex. dibutyl phthalate (DBP), dioctyl phthalate (DOP), dicyclohexyl phthalate) and others(ex. tricresyl phosphate), can be added to or mixed into said synthetic resin used in the invention.

[Water Retention Agent]

Said water retention agent used in the present invention may include an organic or inorganic water retaining agent such as water retaining polyhydric alcohol such as ethylene glycol, diethylene glycol, diethylene glycol monoethyl ether, tetraethylene glycol, polyethylene glycol, propylene glycol, dipropylene glycol, trimethylene glycol, glycerine, 1,2,6-hexanetriol, and the like, amine group compounds such as monomethyl amine, dimethyl amine, trimethyl amine, monoethyl amine, diethyl amine, triethyl amine, trimethyl hydrochloric amine acid, triethyl hydrochloric amine acid, and the like, anionic surfactants such as higher alcohol sulphate (Na salt or amine salt), alkylallyl hydrochloric sulfone acid (Na salt or amine salt), alkylnaphthalene hydrochloric sulfone acid (Na salt or amine salt), condensed alkylnaphthalene hydrochloric sulfone acid, alkylphosphate, dialkylsulfosuccinate, rosin soap, fatty acid chchloride (Na salt or amine salt) and the like, nonionic surfactants such as polyoxyethylenethylenealkyl-ether, polyoxy-ethylenealkylphenol-ether, polyoxy-ethylene-alkyl-ester, polyoxy-ethylene-alkyl-amine, polyoxy-ethylene-alkylol-amine, polyoxyethylene-alkyl-amid, sorbitanalkyl-ester, polyoxyethylenesorbitanalkyl-ester and the like, cationic surfactants such as octadecyl amine acetate, imidazoline derivative acetate, polyalkylenepolyamine derivative or its derivatives, octadecyltrimethyl ammonium chloride, trimethylaminoethylalkylamidohalogene, alkylpyridiniumsulfate, alkyltrimethylammoniumhalogened or the like, organic and inorganic water retention compounds such as calcium chloride, silica gel or the like.

Polyhydric alcohol has low toxicity, good chemical stability, is noncorrosive and further polyhydric alcohol does not affect the stability of the synthetic resin or its curing reaction, so that said polyhydric alcohol may be a desirable water retention agent in the present invention.

[Manufacture of Moldable Sheet]

To manufacture said moldable sheet of the present invention by impregnating or coating said synthetic resin in (on) to said porous material sheet such as a fiber sheet, synthetic resin foam sheet or the like, generally said water retention agent is added to a liquid synthetic resin, synthetic resin solution or a synthetic resin emulsion to prepare a treatment solution and said porous material sheet is dipped in said treatment solution or a said treatment solution is sprayed onto said fiber sheet, or coated onto said fiber sheet with a knife coater, roll coater, flow coater or the like.

Said water retention agent is added to said treatment solution in an amount of between 0.1 and 50% by mass, but desirably 5 and 40% by mass for the synthetic resin.

To adjust the content of said synthetic resin in said porous material sheet, said porous material sheet into which said synthetic resin is impregnated is pressed with a squeezing roll or press device.

In a case where said porous sheet is a fiber sheet, the thickness of said fiber sheet is reduced by pressing, but if said fiber sheet contains said hollow fibers, the thickness of said fiber sheet elastically recovers after pressing to secure an adequate thickness of said fiber sheet since said fiber sheet containing said hollow fibers has high rigidity. In particular, in a case where said fiber sheet contains fibers having a low melting point, it is preferable to heat said fiber sheet after it has been formed, and melt said fibers having a low meting point, so as to bind said fibers to each other in said fiber sheet. In this case, since the strength and rigidity of the resulting fiber sheet is further improved, the said fiber sheet's workability when impregnated with said synthetic resin is also improved, as well as the ability of said fiber sheet to recover its thickness after pressing being remarkable.

In a case where said fiber sheet contains said hollow fibers, its rigidity may be improved, so that the synthetic resin content in said fiber sheet can be reduced, in comparison with a fiber sheet containing no hollow fibers.

After said synthetic resin is coated on or impregnated into said porous sheet, said porous material sheet is dried with or without additional heating. In a case where said synthetic resin is a thermosetting resin, and if said thermosetting resin is kept at B-stage when said porous material sheet is heat dried, the moldability of said porous material sheet can be maintained for a long time, and molding for a short time at a low temperature can be applied.

As described above, said moldable sheet of the present invention is manufactured, and its rigidity, moldability and the like are the results of said synthetic resin which is coated on or impregnated into said sheet. For said purpose, said synthetic resin is coated on or impregnated into said porous material sheet in an amount in the range of between 5 and 200% by mass, but desirably 10 to 100% by mass, and more desirably 20 to 70% by mass. In a case where its resin content is less than 5% by mass, the resulting porous material sheet has poor rigidity and moldability, and in a case where the resin content is more than 200% by mass, the resulting porous material sheet has poor air-permeability, and poor acoustical properties.

To impregnate said water retention agent into said moldable sheet, said water retaining agent may be impregnated into said porous material sheet before or after said synthetic resin is impregnated into said porous material sheet.

[Manufacture of the Interior Material]

Said moldable sheet of the present invention may be used mainly as a surface material for the interior of a car, for such as head lining, a dash silencer, hood silencer, engine under cover silencer, cylinder head cover silencer, dash outer silencer, dash silencer, fender liner silencer, cowl side silencer, as well as for a floor mat, dash board, door trim, and the like.

To manufacture said interior material, said moldable sheet as a surface material is first put onto a base material, the resulting two layer sheet then being commonly molded by hot-pressing it into a prescribed shape, said moldable sheet being bonded to the surface of said base material, when said two layer sheet is molded by hot-pressing.

To bond said moldable sheet to the surface of said base material, commonly a hot melt sheet such as polyethylene sheet, polypropylene sheet, polyester sheet having a low melting point, polyamide sheet having a low melting point, polyester fiber sheet having a low melting point, polyamide fiber sheet having a low melting point or the like, or a hot met adhesive powder such as polyethylene, polypropylene, polyester having a low melting point, polyamide having a low melting point or the like is (are) put or scattered between or onto the mating surface(s) of said moldable sheet and/or said base material.

Said hot melt sheet(s) may be previously attached to said moldable sheet and/or said base material.

Said hot melt sheet is commonly produced by extruding heated and melted hot melt adhesive from a T-die, it being desirable that said moldable sheet and said base material be bonded together by said hot melt sheet while said hot melt sheet is in a melted state.

As said base material, a resin felt in which fibers are bonded together by synthetic resin, a fiber board, a synthetic resin foam such as polyurethane foam into which a synthetic resin is impregnated, cardboard, plastic board such as polypropylene board, polyvinylchloride board or the like are used.

EXAMPLES to explain concretely the present invention are described below.

### EXAMPLE 1

Diethylene glycol (DGE) was added to a phenol-formaldehyde precondensate (50% by mass aqueous solution) in amounts of 0.1, 5.0, 10.0, 20.0, 40.0, 50.0% by mass respectively for the solid in the solution, to prepare mixed solutions. Said mixed solutions were each then coated on and impregnated into fiber sheets, being needle punched nonwoven fabrics made of polyester fiber having a unit weight of 150 g/m², in a coating amount to be 45 g/m², 30% by mass as a solid by using a roll coater, after which said nonwoven fabrics were each dried at 120 to 130° C. for two minutes, to put said precondensate in each nonwoven fabric at its B-stage, to prepare the moldable sheet samples A.

### EXAMPLE 2

Polyethyleneglycol (PEG) was added to an acrylic resin emulsion (50% by mass solid content) in amounts of 0.1, 5.0, 10.0, 20.0, 40.0, 50.0% by mass for solid of said acrylic emulsion to prepare mixed solutions.

Glass fiber sheets having a unit weight of 100 g/m² were put on fiber sheets, being polyester fiber spun bonded nonwoven fabric having a unit weight of 30 g/m², and said mixed solutions were each spraycoated onto said glass fiber sheets in a coating amount to be 60 g/m², 60% by mass as a solid, after which said two layer sheets were each dried at 120 to 130° C. for two minutes, to prepare moldable sheet samples B onto which said polyester nonwoven fabrics were respectively laminated.

[Comparison 1]

Moldable sheet samples C were prepared in the same manner as in EXAMPLE 1 with the exception that diethylene glycol was added separately to said phenol-formaldehyde precondensate aqueous solutions in an amount of 0.05, 60.0% by mass.

[Comparison 2]

Moldable sheet samples D with polyester nonwoven fabrics were prepared in the same manner as in EXAMPLE 2 with the exception that polyethyleneglycol added to said acrylic resin emulsion separately in an amount of 0.05, 60.0% by mass.

Using said moldable sheet samples A and C prepared in EXAMPLE1 and COMPARISON 1, water retention property, bending property, moldability, and water repellency were determined. The results are shown in Table 1. Further, using said moldable sheet samples B and D prepared in EXAMPLE 2 and COMPARISON 2, water retention property, bending property, moldability B, and moisture resistance were determined. The results are shown in Table 2

TABLE 1

| | | Water | | | |
|---|---|---|---|---|---|
| | | retention | | | |
| | | property | | | |
| | DEG content | (moisture | Bonding | | |
| | added | percentage) | property | | Water |
| | (mass %) | (mass %) | (m, m) | moldability | repellency |
| EXAMPLE 1 | 0.1 | 3.5 | 127 | Δ | 3° 30′ |
| | 5.0 | 4.0 | 112 | ⊚ | 3° 20′ |
| | 10.0 | 6.3 | 98 | ⊚ | 3° 15′ |
| | 20.0 | 7.4 | 90 | ⊚ | 2° 57′ |
| | 40.0 | 10.9 | 85 | ⊚ | 2° 30′ |
| | 50.0 | 16.5 | 63 | ◯ | 1° 50′ |
| COMPARIOSON 1 | 0 | 0.2 | 163 | XX | 3° 55′ |
| | 0.05 | 1.3 | 156 | XX | 3° 50′ |
| | 60.0 | 21.2 | 58 | X | 48′ |

TABLE 2

| | PEG content | Water retention property | | |
|---|---|---|---|---|
| | added | (moisture percentage) | Moldability | Moisture |
| | (mass %) | (mass %) | B | resistance |
| EXAMPLE 2 | 0.1 | 3.0 | ◯ | ◯ |
| | 5.0 | 4.4 | ⊚ | ◯ |
| | 10.0 | 5.2 | ⊚ | ◯ |
| | 20.0 | 8.7 | ⊚ | ◯ |
| | 40.0 | 10.4 | ⊚ | ◯ |
| | 50.0 | 18.9 | ⊚ | Δ |
| COMPARISON 2 | 0 | 0.3 | X | ◯ |
| | 0.05 | 1.4 | X | ◯ |
| | 60.0 | 22.3 | ⊚ | X |

[Test Method]

[Water Retention Property]

The unit weight (M1: g/m²) of each moldable sheet sample was determined just after drying, after which each sample was left standing at 10° C., humidity 16% RH for 24 hours, following which the unit weight (M2: g/m²) of each sample was determined, and moisture percentage was calculated using the following formula.

Moisture percentage (% by mass)=(M1−M2)/coating amount (g/m²)×100

[Bending Property]

The resulting moldable sheet samples were respectively left standing at 10° C., humidity 16% RH for 24 hours, after which said samples were each cut lengthwise to prepare test pieces, each test piece being 2 cm×20 cm, their rigidity was determined according to JIS-L1096, bending property 8.19.1A method in Testing methods for woven fabrics (cantilever method).

[Moldability]

The resulting moldable sheet samples A, C were each cut to prepare test pieces having a size of about 1000×1500 mm respectively, and each test piece was left standing at 10° C., humidity 16% RH for 24 hours. Following this, uncured glass wool web was put on each test piece, said glass wool web having been coated with a phenol group resin, the unit weight of said glass wool web being 700 g/m².

The resulting two layer structure samples were each hot-pressed at 210° C. for one minute to be molded into an arbitrary shape, after which the aspects of the resulting molded two layer structure samples were each observed according to the criterion described below.
⊚: The resulting molded two layer structure sample has a good aspect, is shaped as prescribed, and is trouble free.
◯: The resulting molded two layer structure sample has a good aspect, and is shaped as prescribed, but the surface of said molded sheet sample is a little tacky.
Δ: The surface of the complex shaped part of the resulting molded two layer structure sample is a little wrinkled.
×: The surface of the resulting molded two layer structure sample has some imperfection as a result of the foaming of the synthetic resin, since said sample had a high moisture percentage.
××: The surface of a complex shaped part of the resulting molded two layer structure sample has wrinkles and delamination is observed between said fiber sheet and said glass wool web on the L-shaped part of said sample.

[Moldability B]

The resulting moldable sheet samples B, D were each cut to prepare test pieces having a size of about 1000×1500 mm respectively, and each test piece was left standing at 10° C., humidity 16% Rh for 24 hours. A rigid polyurethane foam was attached to the backside of a surface material made of polyester fibers with a hotmelt adhesive film The resulting two layer structure was then put on the glass fiber sheet of each test piece with a hotmelt adhesive to prepare multilayers structure sample being reinforced by said test piece of said moldable sheet.

Said multilayer structure samples were then each hot-pressed at 120° C. for one minute to be molded into an arbitrary shape and the aspect of the resulting molded multilayer structure samples were each observed according to the criterion below.
⊚: Moldability is good, and there is no defect on the surface.
Δ: There appear few marks where a moldable sheet is attached on the surface of a complex shaped part of the resulting molded two layer structure sample.
×: The surface of a complex shaped part of the resulting molded two layer structure sample has wrinkles, resulting in surface appearance trouble.

[Water Repellency]

The resulting moldable sheet samples were each cut to prepare test pieces having a size of about 1000×1500 mm respectively, each test piece was then left standing at 10° C., humidity 16% RH, for 24 hours. Following this glass wool web was put on each test piece, said glass wool web having been coated with a phenol resin, the unit weight of said glass wool web being 700 g/cm².

The resulting two layer structure samples were then each hot-pressed at 210° C. for one minute to be molded into a shape with a thickness of 10 mm, after which 0.1 ml of distilled water was dripped at random with a syringe from a height of less than 5 mm, on to the 10 spots onto the fiber sheet side of each resulting molded articles, the beads of water being observed as time elapsed.

As for water repellency, the time when the number of said beads of water reached five was determined, the other beads having been impregnated into the nonwoven fabrics.

[Moisture Resistance]

The resulting molded article from said moldable sheet B was left standing at 70° C., 95% RH, for 168 hours. The resulting conditions were observed, each according to the criterion below.
◯: the resulting molded multilayer structure sample has an accurate shape and good rigidity, so that there is no trouble in the transportation and/or attachment of said sample.
Δ: The resulting molded multilayer structure sample has an insufficient rigidity, and careful work may be necessary in the transportation and/or attachment of said sample
×: the rigidity of the resulting molded multilayer structure sample is further degraded, and the shape of said molded sample deforms in the transportation and/or attachment of said sample.

Referring to Table 1, in a case where the DEG content for said synthetic resin is in the range of between 0.1 and 50% by mass, moisture percentage of said sample is kept in the range of between 3 and 20% by mass even at low temperature and low humidity, so that sufficient rigidity of the sample is secured, and especially in a case where the DEG content is in the range of between 5.0 and 40.0% by mass, excellent moldability is obtained, and good water repellency of said sample is confirmed.

In COMPARISON 1, the sample without the DEG added or the sample in which the DEG content is below 0.1% by mass, the moisture percentage becoming less than 3% by mass at low temperatures and low humidity, each result in a high rigidity so that wrinkles and delamination are produced in the complex shaped part. Further in COMPARISON 1, in the case of the sample whose DEG content is beyond 50% by mass, the moisture percentage of said sample becomes more than 20% by mass, and said sample has a insufficient rigidity, the foaming phenomenon is produced by the evaporation of water during molding, the surface of said sample becoming hydrophilic, so that the water repellency of said sample is degraded.

Referring to Table 2, in a case where the PEG content for the synthetic resin is in the range of between 0.1 and 50% by mass, the moisture percentage is kept in the range of between 3 and 20% by mass even at low temperatures and low humidity, and especially in a case where the PEG content is in the range of between 5.0 and 50% by mass, the desirable moldability of said sample is secured, and further especially in a case where the, PEG content is in the range of between 0.1 and 40.0% by mass, a desirable moisture vapor resistance is secured.

In COMPARISON 2, the sample without the PEG or the sample in which the PEG content is below 0.1% by mass, each have a moisture percentage below 3% by mass at low temperatures and low humidity, degrading the moldability of said sample. Further in a case where the PEG content is beyond 50% by mass in COMPARISON 2, the moisture percentage of the sample becomes beyond 20% by mass, resulting in its moisture resistance being degraded.

### EXAMPLE 3

A mixed solution was prepared by mixing 30 parts by mass of a sulfomethylated phenol-alkylresorcin-formaldehyde precondensate (solid content: 50% by mass, aqueous solution), 5 parts by mass of ethyleneglycol, 1 part by mass of a carbon black dispersion (solid content:35% by mass aqueous dispersion), 2 parts by mass of water and an oil repellent containing fluorine (solid content 20% by mass aqueous solution), 2 parts by mass of a fire retardant (containing nitrogen and phosphorous solid content 50% by mass aqueous solution) and 60 parts by mass of water.

Said mixed solution was then coated on and impregnated in to a fiber sheet, being a spunbonded nonwoven fabric made of polyester fibers having a unit weight of 30 g/m², by the roll in a coating amount to be 45% by mass, after which said fiber sheet was then dried at 120 to 130° C. for one minute to put said precondensate in said fiber sheet at its B-stage, to obtain a moldable sheet. The resulting moldable sheet was then used as a surface material, and was put on an uncured glass wool web as a base material (unit weight 600 g/m²) on to which a phenol group resin was coated at 9° C., humidity 12% RH, after which the resulting two layer structure sample was then molded by hot pressing at 200° C., for one minute into an arbitrary shape to manufacture a moldable two layer sheet. The resulting molded sheet had no trouble in its surface aspect even while being handled at the low temperature of 9° C., and low humidity of 12% RH, and said molded sheet had excellent water resistance and flame retardancy, so that said molded sheet was useful as a hood silencer, dash silencer, dash outer silencer, and engine under cover silencer and the like for a car.

[Comparison 3]

A moldable sheet was obtained in the same manner with exception that no ethylene glycol was added, and 35 parts by mass of sulfomethylated-phenol-alkylresorcin-form aldehyde precondensate (solid content 50% by mass aqueous solution) was mixed therein. The resulting molded sheet was inferior in that wrinkles was produced on its surface in the complex shaped part, and there was a trouble in its production efficiency.

### EXAMPLE 4

A mixed solution was prepared by mixing 40 parts by mass of a sulfimethylated phenol-alkylresorcin-form aldehyde precondensate (solid content 50% by mass aqueous solution), 2 parts by mass of polyethylene glycol, 1 part by mass of a carbonblack dispersion (solid content 35% by mass aqueous dispersion), 3 parts by mass of a water and oil repellent containing fluorine (solid content 20% by mass aqueous solution), 4 parts by mass of a fire retardant (containing nitrogen and phosphorous, solid content 50% by mass aqueous solution), and 50% by mass of water, after which said mixed solution was then coated on and impregnated into a fiber sheet, being spunbonded nonwoven fabric made of polyester fibers (unit weight 50 g/m²) by the roll in an amount to be 40% by mass, after which said fiber sheet was then dried at 120 to 130° C., to precure for one minute, and put said precondensate at its B-stage, to obtain a moldable sheet.

The resulting moldable sheet was used as a surface material, and said moldable sheet was put on an uncured reclaimed felt as a base material (unit weight 1000 g/m²) onto which a phenol group resin was coated at 8° C., humidity 8% RH. The resulting two layer structure sheet was then molded by hot-pressing at 210° C. for one minute into an arbitrary shape to obtain a molded sheet.

The resulting molded sheet had no trouble in its surface aspect, and even at the low temperature of 8° C. and low humidity 8% RH, said molded sheet had excellent water resistance and flame retardancy, so that said molded sheet was useful as a hood silencer, dash silencer, dash outer silencer, engine under cover silencer and the like for a car.

### EXAMPLE 5

A mixed solution was prepared by mixing 30 parts by mass of a phenol-alkylresorcin-formaldehyde precondensate (solid content 50% by mass aqueous solution), 1 part by mass of ethylene glycol, 1 part by mass of a carbon black dispersion (solid content 35% by mass aqueous dispersion), 3 parts by mass of a water-oil repellent containing fluorine (solid content 20% by mass aqueous solution), 4 parts by mass of poly ammonium phosphate (particle size 50 to 60 μm) and 61 parts by mass of water. The resulting mixed solution was coated by the roll onto a fiber sheet, being a needle punched nonwoven fabric having a unit weight of 100 g/m² and made of polyester fibers, and impregnated in an amount to be 40% by mass. Following this, a polyamide powder (softening point: 115° C., particle size: 40 to 50 μm) as a hotmelt adhesive was coated onto said fiber sheet in an amount to be 5 g/m², after which said fiber sheet was then dried at 120 to 130° C. for one minute to precure and put said precondensate in said fiber at its B-stage, to obtain a moldable sheet, said hot melt adhesive being fixed to said fiber sheet.

The resulting moldable sheet was then used as a surface material, and said moldable sheet was put on a polyurethane foam as a base material which is treated by a flame retardant, so as to join said hotmelt adhesive of said moldable sheet to said polyurethane foam at 8° C., humidity 8% RH, said polyurethane foam having a unit weight 200 g/m² and thickness 20. The resulting two layer structure sheet was then molded by hot-pressing at 180° C. for one minute into an arbitrary shape, to obtain a molded sheet.

The resulting molded sheet had no trouble in its surface aspect even during handling at the low temperature of 8° C. and a low humidity 8% RH and said molded sheet was useful as a hood silencer, head lining, dash silencer, dash outer silencer, engine under cover silencer and the like for a car.

### EXAMPLE 6

A mixed solution was prepared by mixing 40 parts by mass of a sulfomethylated-phenol-alkylresorcin-formaldehyde precondensate (solid 50% by mass aqueous solution), 0.5 part by mass of glycerin, 1 part by mass of a carbonblack dispersion (solid content 35% by mass aqueous dispersion), 2 parts by mass of a water-oil repellent containing fluorine (solid content 20% by mass aqueous solution), 3 parts by mass of a flame retardant containing nitrogen and phosphorous (solid content 50% by mass aqueous solution), and 53.5% by mass of water. The resulting mixed solution was then coated onto a fiber sheet (unit weight: 100 g/m², length: 150 m, width: 1500 mm), being a needle punched nonwoven fabric made of polyester fibers, and impregnated into said fiber sheet in an amount to be 30% by mass, after which said fiber sheet was then dried and precured at 120 to 130° C. for one minute, to put said precondensate in said fiber sheet at its B-stage. The resulting moldable sheet was then taken up on a paper tube having a diameter of 75 mm, and packed with the craft paper to obtain a scroll with a diameter of 150 mm said scroll was then left standing in a room at 10 to 25° C., humidity 12 to 10% Rh for one month, following which said scroll was unpacked from the craft paper. After unpacking said scroll, said moldable sheet was unrolled, being used as a surface material, under indoor environmental condition, at the temperature of 13° C., humidity of 15% RH, during the molding process as shown in FIG. 1, said moldable sheet was put on an uncured glass wool web as a base material (unit weight 600 g/m²) onto which a phenol group resin was coated, and the resulting two layer structure was then continuously hot-pressed at 210° C. for one minute to obtain molded sheet units, each unit having a size of about 800 mm×1400 mm.

Referring to FIG. 1, said moldable sheet 1 was unrolled from the roll 1A and put on said base material 2 on the belt conveyer 3, and then continuously molded by the press molding machine 5 which consists of an upper mold part 5A and a lower mold part 5B, then cut by the cutter 6 into a plural number of molded sheet units 7, each having a prescribed size, after which each unit was stored. The resulting molded sheet unit 7 had good aspects and performance, and there were no defective molded sheets. Further, the moisture percentage of the part of said moldable sheet just after being unrolled from the scroll, the middle part of said moldable sheet in the scroll, and the core part of said moldable sheet in the scroll were each 13.4, 13.7, 13.9% respectively.

[Comparison 4]

A moldable sheet was prepared in the same manner as in EXAMPLE 6 with the exception that 54.0 parts by mass of water was used instead of glycerin, and the resulting molded sheet units made of the part of said moldable sheet just after being unrolled from the scroll to the middle parts of said moldable sheet in the scroll produced wrinkles on the surface area of the complex shaped part, and 46% of the molded sheet units were defective. Further, the moisture percentage of the part of said moldable sheet just after being unrolled from the scroll, the middle part of said moldable sheet in the scroll, and the core parts of said moldable sheet in the roll were each 1.5, 4.8, 10.8% respectively.

Referring to the results of EXAMPLE 6 and COMPARISON 4, the moldable sheet samples without said water retention agent had insufficient water retention properties so that the moisture percentage of said moldable sheet sample decreased during storage, so resulting in said moldable sheet sample not being able to correspond to complex shapes during molding, and resulting in surface aspect trouble.

Possibility of Undustrial Use

In the present invention, a moldable sheet giving a molded article a good aspect even at a low temperatures and humidity is provided. Said moldable sheet may be useful as interior material for a car etc.

### BRIEF DESCRIPTION OF DRAWING

FIG. 1 illustrates the molding process.

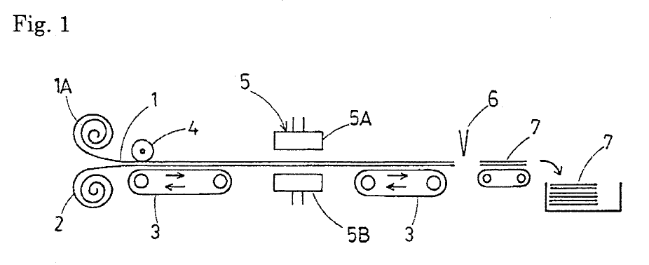

1. A moldable sheet comprising a porous material which a synthetic resin is coated on or impregnated into, said porous material being further impregnated with a water retention agent.

2. A moldable sheet comprising a porous material in accordance with claim 1, wherein said synthetic resin is a phenol group resin, and at B-stage in said porous material.

3. A moldable sheet comprising a porous material in accordance with claim 2, wherein said phenol group resin is sulfo and/or sulfi methylated.

4. A moldable sheet comprising a porous material in accordance with claim 1, wherein said water retention agent is a polyhydric alcohol.

5. A moldable sheet comprising a porous material in accordance with claim 1, wherein said synthetic resin is impregnated into said porous material in an amount between 5 and 200% by mass, with said water retention agent being impregnated into said porous material in an amount of between 0.1 and 50% by mass for said synthetic resin.

6. An interior material which is made by putting said moldable sheet as a surface material onto a base material, and hot press-molding.

7. A moldable sheet comprising a porous material in accordance with claim 2, wherein said water retention agent is a polyhydric alcohol.

8. A moldable sheet comprising a porous material in accordance with claim 3, wherein said water retention agent is a polyhydric alcohol.

9. A moldable sheet comprising a porous material in accordance with claim 2, wherein said synthetic resin is impregnated into said porous material in an amount between 5 and 200% by mass, with said water retention agent being impregnated into said porous material in an amount of between 0.1 and 50% by mass for said synthetic resin.

10. A moldable sheet comprising a porous material in accordance with claim 3, wherein said synthetic resin is impregnated into said porous material in an amount between 5 and 200% by mass, with said water retention agent being impregnated into said porous material in an amount of between 0.1 and 50% by mass for said synthetic resin.

11. A moldable sheet comprising a porous material in accordance with claim 4, wherein said synthetic resin is impregnated into said porous material in an amount between 5 and 200% by mass, with said water retention agent being impregnated into said porous material in an amount of between 0.1 and 50% by mass for said synthetic resin.
